(19) United States
(12) Patent Application Publication
(10) Pub. No.: US 2026/0178966 A1
(43) Pub. Date: Jun. 25, 2026

(54) METHOD AND SYSTEM FOR TARGET PREDICTION VIA REVERSIBLE TARGET COMPRESSION AND APPLICATION THEREOF

(71) Applicant: Verizon Patent and Licensing Inc., Basking Ridge, NJ (US)

(72) Inventors: Parthasarathy Vijayan, Chennai (IN); Praveenkumar Chandrasekaran, Chennai (IN)

(73) Assignee: Verizon Patent and Licensing Inc., Basking Ridge, NJ (US)

(21) Appl. No.: 18/999,646

(22) Filed: Dec. 23, 2024

(51) Int. Cl. G06N 20/00

(52) U.S. Cl. CPC G06N 20/00

(57) ABSTRACT

The present teaching relates to compressing targets to be predicted. Past metrics of original targets and past feature data related to network operation are collected. Combinations of the original targets are generated and some of which are identified as candidate compressed targets. Some candidate compressed targets are selected based on predetermined criteria to generate a modified set of targets with both compressed targets and the remaining original targets. Obtain a target prediction model via machine learning based on relevant training data associated with each of the modified set of targets for predicting metrics thereof.

### BACKGROUND

With the increased amount of data flowing over telecommunication networks and advancements in big data analytics, different metrics may be predicted using models trained on historical data. For example, in managing a network with wireless base stations, a network operator may like to determine metrics related to the remaining lifespan of each base station or tower, or the geographical coverage of the signals of different base stations or towers, etc. Such metrics may be estimated based on data related to each tower, including static data such as the installation date of the tower or its physical dimension or dynamic data such as the weather condition surrounding the tower and the strength of the signals transmitted. Dynamically estimating operation related metrics associated with a network enables the network operator to adaptively adopt measures to optimize the network performance.

### BRIEF DESCRIPTION OF THE DRAWINGS

The methods, systems and or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 shows an exemplary target prediction application related to network management;

FIG. 2 illustrates exemplary types of data features used to predict exemplary target metrics related to network management;

FIG. 3A depicts an exemplary framework for target prediction using prediction models for condensed targets, in accordance with an embodiment of the present teaching;

FIG. 3B illustrates exemplary types of targets that may be condensed, in accordance with an embodiment of the present teaching;

FIG. 3C shows exemplary correlated original targets which may be condensed, in accordance with an embodiment of the present teaching;

FIG. 3D illustrates exemplary dimension reduction scheme to condense correlated original targets, in accordance with an embodiment of the present teaching;

FIG. 4A depicts an exemplary system diagram of a framework for compressing original targets and obtaining prediction models therefor, in accordance with an embodiment of the present teaching;

FIG. 4B is a flowchart of an exemplary process of a framework for compressing original targets and obtaining prediction models therefor, in accordance with an embodiment of the present teaching;

FIG. 5A depicts an exemplary system diagram of a target compression unit, in accordance with an embodiment of the present teaching;

FIG. 5B is a flowchart of an exemplary process of a target compression unit, in accordance with an embodiment of the present teaching;

FIG. 5C illustrates exemplary types of reversible target compression approaches;

FIG. 6 is an illustrative diagram of an exemplary mobile device architecture that may be used to realize a specialized system implementing the present teaching in accordance with various embodiments; and

FIG. 7 is an illustrative diagram of an exemplary computing device architecture that may be used to realize a specialized system implementing the present teaching in accordance with various embodiments.

### DETAILED DESCRIPTION OF EXAMPLE EMBODIMENTS

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings. With increasing amounts of data available, data is often leveraged to build models for predicting some targeted metrics. One example is related to network management. Historical network operational data may be used to develop prediction models for detecting target metrics based on real-time operational data. Such predictions are important for network management to dynamically determine measures to ensure smooth network operation to deliver satisfactory services. For example, in wireless network operation, a tower's life span may be predicted based on real-time data so that appropriate measures such as maintenance needed may be dynamically determined to ensure that the tower continues to meet the performance requirements. There are different approaches to develop prediction models. A typical framework is to develop a separate prediction model for each target metric. That is, if there are N targets to predict, N target prediction models is used, each of which is for predicting, based on data collected related to a specific target metric is collected and used to train a dedicated target prediction model. In this framework, each of the target prediction models needs to be trained and maintained separately. Although each prediction model is specifically trained with respect to a particular target metric, it is expensive to do so considering both resources and time required. An alternative framework is to use a general model to predict multiple targets. In this scheme, an overall prediction model is trained using data related to all targets to be predicted. Although only one model needs to be trained and maintained, it is usually at the expense of the performance in accurately predicting individual target metrics.

The unsatisfactory situation using either of the scenarios may be more challenging in some applications. For instance, a wireless network may include many towers, each of which is to provide coverage of different local areas. Adjacent towers transmit signals to each other to ensure smooth transition in order to provide quality geographical coverage of a much larger region. The performance of each of the towers may impact on the service quality so that it is important to predict, in real-time operation, certain target metrics associated with each tower based on operational data associated therewith.

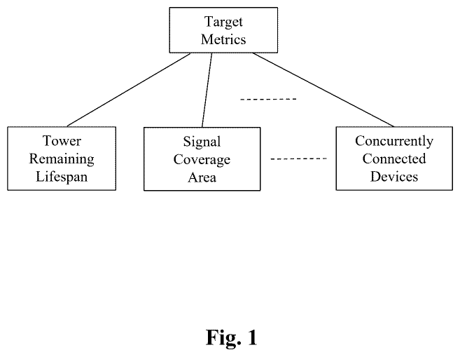

FIG. 1 shows an exemplary target prediction application related to wireless network management. Target metrics associated with a tower may be specified to include, e.g., the remaining lifespan of each tower (which may impact how the tower should be maintained), the coverage area of the signals transmitted by the tower (which may impact the quality of services), or the number of devices that can concurrently connect to a tower (which may determine the resources to be allocated to the tower).

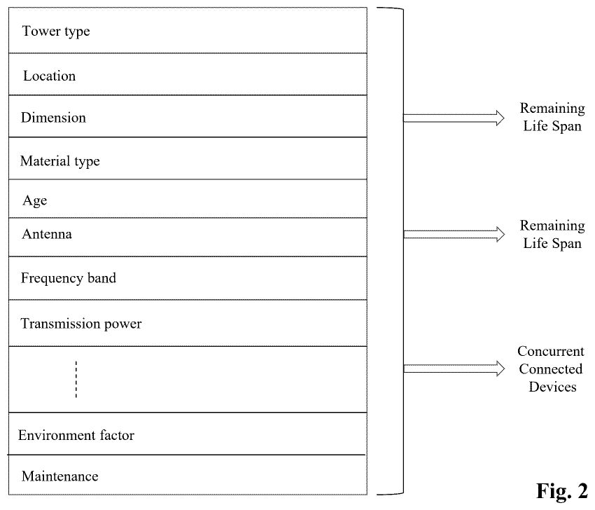

The exemplary target metrics as shown in FIG. 1 may be influenced by different factors, including structural, geographical, functional, and environmental. Feature data related to such factors may be collected dynamically in operation and used to predict the target metrics. FIG. 2 illustrates exemplary types of feature data that may be used to predict exemplary target metrics related to network management, including tower type, geographical location, dimension, type of material used to build the tower, the age of the tower, the type of antenna installed, the frequency band(s) used for transmitting signals, the transmission power specified, different environmental factors such as current weather, temperature, humidity, etc., and its maintenance history. While different target metrics may all be impacted by these feature data, some may be influenced in a similar way, and some may be in different ways.

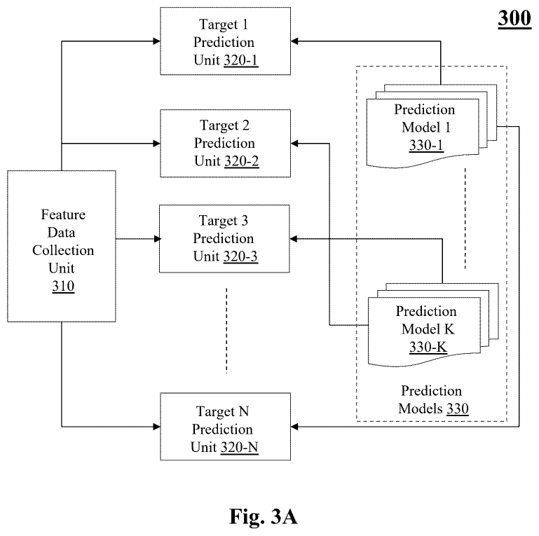

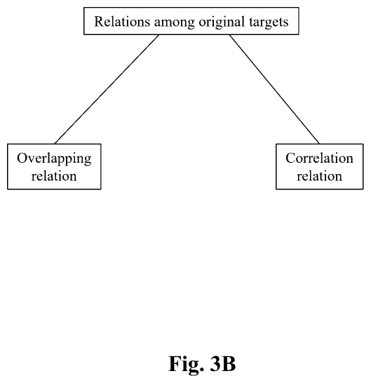

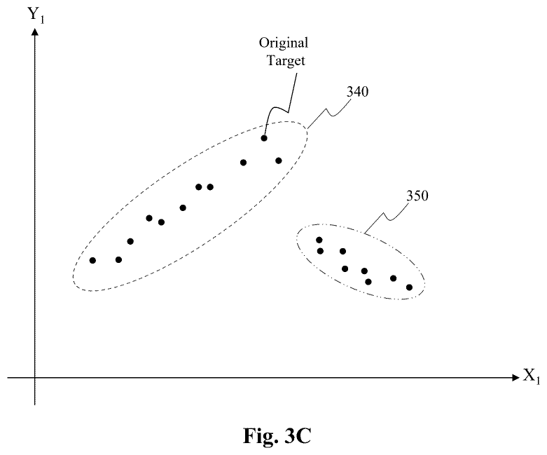

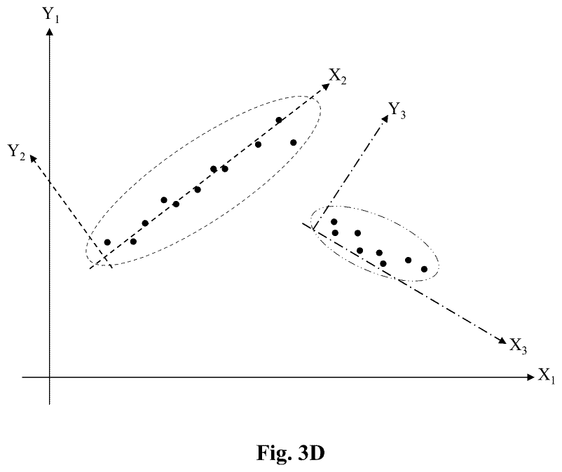

The present teaching discloses a scheme to balance the number of prediction models to be trained and the prediction quality by condensing or compressing original targets to generate condensed targets. This is shown in FIG. 3A, where K prediction models 330-1 to 330-K are used by N target prediction units 320-1 to 320-N, where N>K, to predict N target metrics based on feature data collected by a feature data collection unit 310. A condensed target may also be referred to in this disclosure as a unified, a compressed, or a combined target. A condensed target may be created based on some relationship existing among the original targets that are condensed. Some exemplary types of relationships that may trigger the compression of multiple original targets are illustrated in FIG. 3B. As shown, the relationships existing between/among original targets that may be used to condense related original features include, e.g., overlapping or correlation relations. If original targets are overlapping, it may indicate that one is redundant so that they may be condensed to generate a unified target. If multiple original targets are correlated, one may be inferred or determined from another correlated original target. In either case, the original targets with such relations may be condensed or unified as one combined target which may be predicted using a prediction model.

FIG. 3C shows exemplary original targets which are correlated and may be condensed, in accordance with an embodiment of the present teaching. In FIG. 3C, each dot represents an original target in an exemplary two-dimensional coordinate system denoted by X1-Y1. The coordinate along each axis corresponds to a value of a feature denoted by that axis. There are two groups of original targets that are substantially correlated. One is group 340 and the other 350. Original targets in each group are correlated according to some linear relation, which may be identified via data analytics and used for dimension reduction via a transformation determined based on the linear relation. FIG. 3D illustrates exemplary condensed targets in respective dimension-reduced spaces to represent the original targets as shown in FIG. 3C, in accordance with an embodiment of the present teaching. According to the linear relation detected among original targets in 340, a condensed target may be created by combining the original targets in 340 in a transformed coordinate system X2-Y2, in which original targets in 340 are substantially one-dimensional and change in their values mainly with respect to their transformed values along X2 axis. Similarly, according to the linear relation detected among original targets in 350, another condensed target may be created by combining original targets in 350 in a different transformed coordinate system X3-Y3, in which original targets in 350 are now substantially one-dimensional and change in their values mainly with respect to their transformed values along X3 axis.

The condensed targets may effectively reduce the number of targets that need to be predicted so as to reduce the number of models that need to be trained. As illustrated in FIG. 3A, target 1 and target N are predicted using the same prediction model 1 (330-1) as they are now combined as the same condensed target. Given that, the target prediction model 1 330-1 may be trained for predicting multiple original targets because these original targets are condensed as one due to their related behavior. It is noted that the target compression scheme as disclosed herein may introduce some loss, depending on how original targets are condensed. The loss may be determined based on the deviation between a prediction of an original target using a model trained to be dedicated to the original target prediction and a prediction from a model trained for the condensed target. For instance, in FIG. 3D, the original target points in each condensed target (340 or 350) may not all reside precisely on their respective transformed X axes, such deviations may correspond to the loss when the predictions on a condensed target are used as predictions of the original targets combined in that condensed target. i.e., when there may be some loss when predicting a condensed target, the compression process to condense the original targets according to the present teaching may be provided to balance the loss with the reduction according to some specification, which may be determined based on the need of each application.

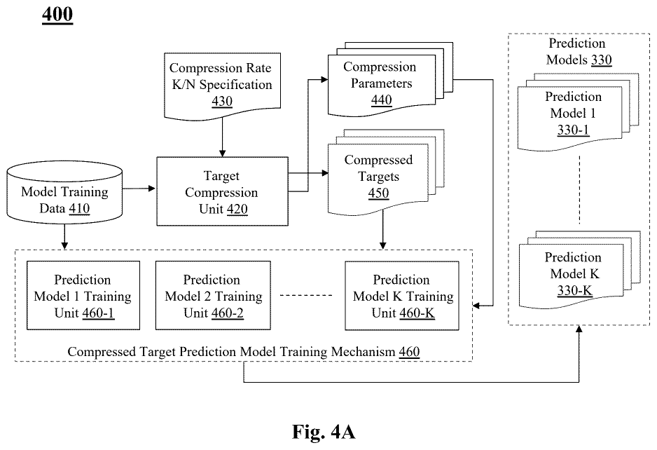

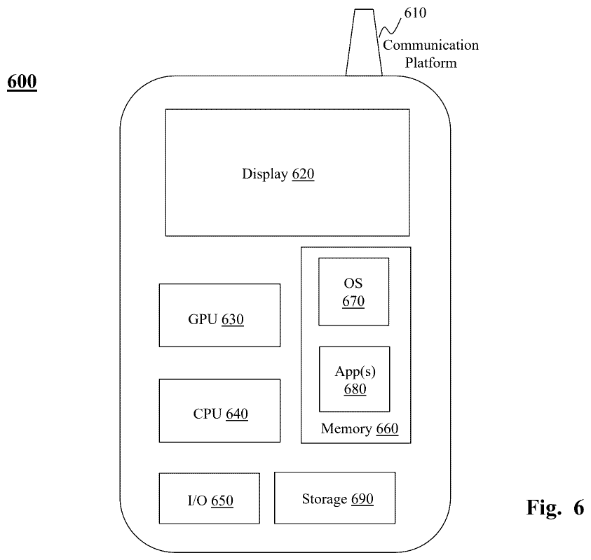

FIG. 4A depicts an exemplary system diagram of a framework 400 for compressing original targets and obtaining prediction models therefore, in accordance with an embodiment of the present teaching. In this illustrated embodiment, the framework 400 is provided for establishing a number of prediction models to predict multiple multivariant original targets to balance the costs and the performance. The framework 400 comprises a target compression unit 420 and K prediction model training units 460. To enable the function of framework 400, past data is collected and stored in a model training data 410, which may include feature data associated with N original targets from past application operations. For instance, if the application is for management of a wireless network having a plurality of towers, the model training data 410 may include data features observed in past operations as well as past logged metrics associated with different original targets (as illustrated in FIGS. 2A-2B).

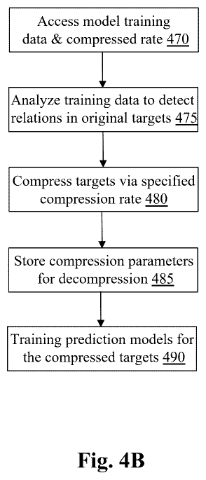

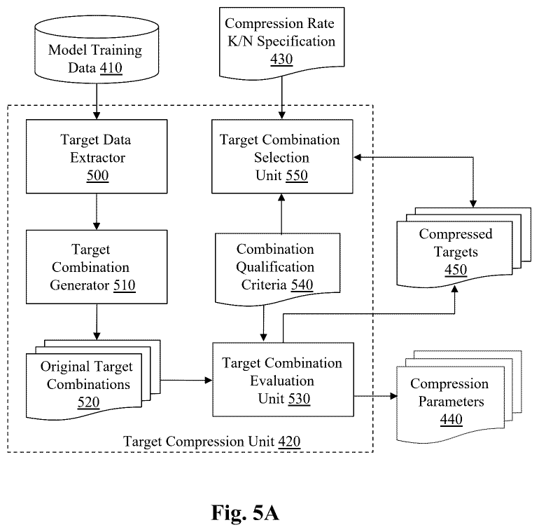

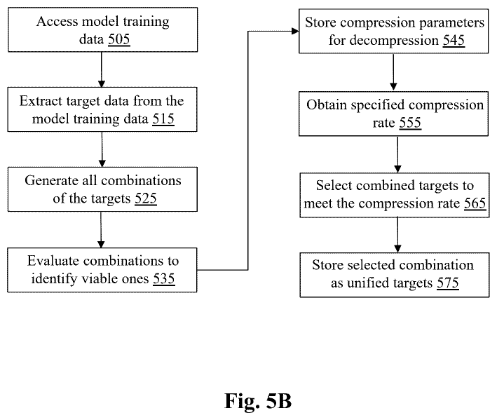

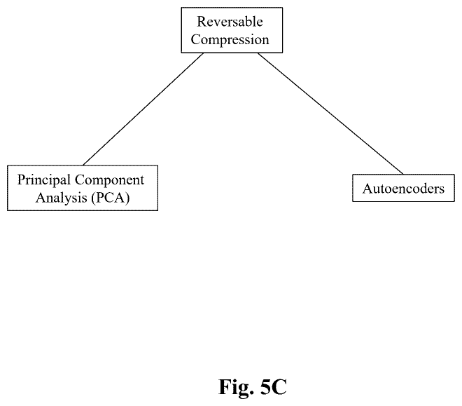

The target compression unit 420 is provided to analyze the model training data 410 to identify original targets therein that may be condensed and accordingly create K compressed targets 450. As discussed herein, the process of condensing original targets may be carried out by balancing the efficiency and loss. In some embodiments, the target compression unit 420 may operate based on a desired compression rate, such as a ratio between the number of original targets and the number of remaining targets after some original targets are combined as condensed targets. For example, there may be N original targets, some of which may be combined as condensed targets, and some remain as individual original targets. The final number of targets after compression may be K. In this example, the compression ratio may be defined as K/N. Based on this desired compression rate, the target compression unit 420 may further operate to balance the desired compression rate with an acceptable degree of loss. Details related to the target compression unit 420 are provided with reference to FIGS. 5A-6.

In some embodiments, each of the K compressed targets 450 may be created with a specification as to the original targets condensed therein. Such information associated with each compressed target may be provided to the corresponding prediction model training units 460 to select relevant data from the model training data 410 to carry out the training. That is, each prediction model training unit for training a particular prediction model for one of the compressed targets may extract some of model training data related to the original targets condensed in the compressed target and rely on the extracted relevant training data for deriving the particular prediction model.

FIG. 4B is a flowchart of an exemplary process of the framework 400 for compressing original targets and obtaining prediction models therefor, in accordance with an embodiment of the present teaching. The target compression unit 420 accesses, at 470, model training data 410 and the specified compression rate 430 and analyzes, at 475, the training data to detect relations among the original targets. Based on the analysis, the target compression unit 420 compresses, at 480, the original targets based on the relations and the specified compression rate. In some embodiments, the information about the compressed targets as well as the compression parameters 440 are stored, at 485, so that each of the prediction model training units 460 may selectively access appropriate training data in 410 and to train, at 490, respective prediction models for respective compressed targets.

FIG. 5A depicts an exemplary system diagram of the target compression unit 420, in accordance with an embodiment of the present teaching. In this illustrated embodiment, the target compression unit 420 includes a target data extractor 500, a target combination generator 510, a target combination evaluation unit 530, and a target combination selection unit 550. The target data extractor 500 is provided to identify information from model training data 410 related to original targets. To determine what original targets may be related in a way that they may be condensed, the target combination generator 510 is provided to generate all combinations 520 of the original targets, which are assessed by the target combination evaluation unit 530 as to whether the original targets in each combination may be condensed based on some specified qualification criteria specified in 540. In some embodiments, such criteria may include, e.g., a required level of similarity (e.g., 95% minimum) among original targets in each combination, which may be related to the loss (e.g., 10% maximum) associated with the original targets when their values are predicted via the same prediction model.

In some embodiments, the assessment may be performed based on some techniques to determine whether the original targets in a combination are related in some way. For example, a principal component analysis (PCA) may be applied to detect whether the original targets in a combination are correlated so that the original targets can be condensed in a transformed space as what is shown in FIG. 3D. It is noted that PCA yields a reversible compression with information that may be used to decompress a condensed target. As shown in FIG. 5A, for each of the compressed targets, corresponding compression parameters that may be used to revert each compressed target back to the original targets may be stored in 440 to enable decompression if needed. In some applications, this may be a characteristic required in order to revert a compressed target back to the original targets when needed. Other reversible approaches may also be used to determine how to compress targets in a manner that supports reverting each back to the original targets. FIG. 5C illustrates some exemplary reversible compression schemes, including PCA and autoencoders.

In some embodiments, the target combinations that passed the qualification criteria 540 may be temporarily stored in the K compressed targets 450 for further processing by the target combination selection unit 550. Based on the specified compression rate 430, the target combination selection unit 550 may be provided to select, from the candidate combinations of original targets in 450, top K combinations as the compressed targets to satisfy the specified compression rate.

FIG. 5B is a flowchart of an exemplary process of the target compression unit 420, in accordance with an embodiment of the present teaching. In operation, the target compression unit 420 accesses, at 505, the model training data 410 to extract, at 515, information related to the original targets from the model training data 410. To determine the compressed targets according to the specified compression rate, the target combination generator 510 generates, at 525, all combinations of the original targets in 520. For example, this may include all combinations of two original targets, all combinations of three original targets, etc. The target combination evaluation unit 530 then evaluates, at 535, each of the original target combinations in 520 to identify those combinations that satisfy the qualification criteria 540. Such qualified combinations may correspond to candidates for further selection according to a specified compression rate. To facilitate the selection, each of the candidates may be associated with corresponding assessment parameters such as the similarity, the loss, etc. As discussed herein, each of the candidate combinations may be assessed via reversible compression scheme (e.g., PCA) and the parameters needed to carry out the reversion (e.g., the transformation parameters determined via PCA) may also be stored at 545. The specified compression rate is accessed at 555 by the target combination selection unit 550 and used to select, at 565, top K combinations based on the assessment information of the candidate combinations. For instance, combinations that have maximum similarity among their original targets and minimum loss may be selected. The selected combinations and the remaining original targets satisfy the required compression rate and may be stored in the compressed targets 450, which are then used by multiple prediction model training units 460 to train K prediction models 230.

Each prediction model training unit 460 to be trained for each compressed target may then be trained using appropriate training data from 410, which may be generated based on the compression parameters associated with the compressed target. For example, to generate the appropriate training data related to a compressed target, the compression parameters related to the compressed target may be obtained from 440 and used to guide the generation of the training data appropriate for training the prediction model for the compressed target. For example, as illustrated in FIG. 3D, the compressed target represented by combination 340 is condensed in a transformed space X2-Y2, while its component original targets are initially represented in the original feature space X1-Y1. As such, the original targets in 340 in X1 -Y1 may be transformed to generate transformed compressed target points in X2 -Y2 so that they may be used to train a prediction model for the combined target 340. That is, the prediction model trained using the transformed training data generates predictions in space X2-Y2. However, as the compression is reversible, as discussed herein, each predicted value in space X2 -Y2 may be transformed back to the original X1-Y1 space if needed.

The present teaching facilitates a balance between the costs of obtaining and maintaining prediction models to predict a plurality of original targets and the prediction quality. Such a balance may be dynamically adjusted by specifying a compression rate and a controlled level of loss, both of which may be provided based on needs of each application.

FIG. 6 is an illustrative diagram of an exemplary mobile device architecture that may be used to realize a specialized system implementing the present teaching in accordance with various embodiments. In this example, the user device on which the present teaching may be implemented corresponds to a mobile device 600, including, but not limited to, a smart phone, a tablet, a music player, a handled gaming console, a global positioning system (GPS) receiver, and a wearable computing device, or a mobile computational unit in any other form factor. Mobile device 600 may include one or more central processing units (“CPUs”) 640, one or more graphic processing units (“GPUs”) 630, a display 620, a memory 660, a communication platform 610, such as a wireless communication module, storage 690, and one or more input/output (I/O) devices 650. Any other suitable component, including but not limited to a system bus or a controller (not shown), may also be included in the mobile device 600. As shown in FIG. 6, a mobile operating system 670 (e.g., iOS, Android, Windows Phone, etc.) and one or more applications 680 may be loaded into memory 660 from storage 690 to be executed by the CPU 640. The applications 680 may include a user interface or any other suitable mobile apps for information exchange, analytics, and management according to the present teaching on, at least partially, the mobile device 600. User interactions, if any, may be achieved via the I/O devices 650 and provided to the various components thereto.

To implement various modules, units, and their functionalities as described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

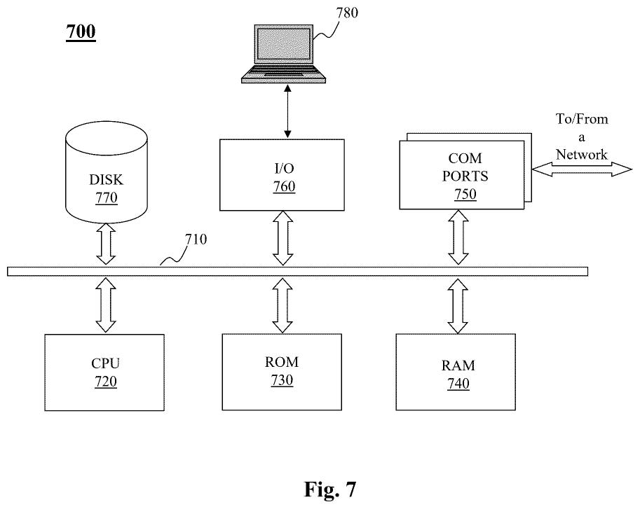

FIG. 7 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 700 may be used to implement any component or aspect of the framework as disclosed herein. For example, the information processing and analytical method and system as disclosed herein may be implemented on a computer such as computer 700, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 700, for example, includes COM ports 750 connected to and from a network connected thereto to facilitate data communications. Computer 700 also includes a central processing unit (CPU) 720, in the form of one or more processors, for executing program instructions. The exemplary computer platform includes an internal communication bus 710, program storage and data storage of different forms (e.g., disk 770, read only memory (ROM) 730, or random-access memory (RAM) 740), for various data files to be processed and/or communicated by computer 700, as well as possibly program instructions to be executed by CPU 720. Computer 700 also includes an I/O component 760, supporting input/output flows between the computer and other components therein such as user interface elements 780. Computer 700 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

It is noted that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

In the preceding specification, various example embodiments have been described with reference to the accompanying drawings. It will, however, be evident that various modifications and changes may be made thereto, and additional embodiments may be implemented, without departing from the broader scope of the present teaching as set forth in the claims that follow. The specification and drawings are accordingly to be regarded in an illustrative rather than restrictive sense.

We claim:

1. A method, comprising:
collecting past metrics of a plurality of original targets measured in past operations of a network as well as past feature data characterizing components of the network;
creating model training data based on the collected past metrics and past feature data, wherein the model training data is for training target prediction models to predict metrics of the plurality of original targets;
generating combinations of the plurality of original targets;
identifying, from the combinations, candidate compressed targets, each of which includes original targets that are related to each other;
selecting one or more compressed targets from the candidate compressed targets based on predetermined criteria;
creating a modified set of targets with both the selected compressed targets and remaining of the plurality of original targets;
deriving a target prediction model dedicated to predicting metrics of each of the modified set of targets by:
extracting, from the model training data, relevant training data associated with the target, and
training, via machine learning, the target prediction model for the target based on the relevant training data.

2. The method of claim 1, wherein the combinations correspond to different groupings of the plurality of original targets.

3. The method of claim 1, wherein the identifying candidate compressed targets comprises:
with respect to each of the combinations,
identifying component original targets included in the combination,
retrieving past metrics of the component original targets from the model training data,
assessing whether the component original targets are related based on the retrieved past metrics,
designating the combination as a candidate compressed target if the component original targets are related.

4. The method of claim 3, wherein the component original targets relate to each other via:
an overlapping relationship; and
a correlation relationship.

5. The method of claim 1, wherein the selecting one or more compressed targets comprises:
obtaining the predetermined criteria comprising a specified compression rate and a specified loss;
determining a loss for each of the compressing the original targets in the candidate compressed target;
identifying qualifying candidate compressed targets that have their respective losses satisfying the specified loss;
ranking the qualifying candidate compressed targets in an ascending order of their respective losses; and
selecting top ranked candidate compressed targets until the specified compression rate is satisfied.

6. The method of claim 5, wherein the compression rate is defined based on a number of targets in the modified set and the number of original targets.

7. The method of claim 1, further comprising:
collecting, in current operation of the network, real-time feature data characterizing the components of the network in the operation;
providing the real-time feature data to the target prediction models; and
predicting, by each of the target prediction models, metrics of an associated target in the modified set of targets based on the real-time feature data.

8. A machine-readable and non-transitory medium having information recorded thereon, where the information, when read by the machine, causes the machine to perform the following steps:
collecting past metrics of a plurality of original targets measured in past operations of a network as well as past feature data characterizing components of the network;
creating model training data based on the collected past metrics and past feature data, wherein the model training data is for training target prediction models to predict metrics of the plurality of original targets;
generating combinations of the plurality of original targets;
identifying, from the combinations, candidate compressed targets, each of which includes original targets that are related to each other;
selecting one or more compressed targets from the candidate compressed targets based on predetermined criteria;
creating a modified set of targets with both the selected compressed targets and remaining of the plurality of original targets;
deriving a target prediction model dedicated to predicting metrics of each of the modified set of targets by:
extracting, from the model training data, relevant training data associated with the target, and
training, via machine learning, the target prediction model for the target based on the relevant training data.

9. The medium of claim 8, wherein the combinations correspond to different groupings of the plurality of original targets.

10. The medium of claim 8, wherein the identifying candidate compressed targets comprises:
with respect to each of the combinations,
identifying component original targets included in the combination,
retrieving past metrics of the component original targets from the model training data,
assessing whether the component original targets are related based on the retrieved past metrics,
designating the combination as a candidate compressed target if the component original targets are related.

11. The medium of claim 10, wherein the component original targets relate to each other via:
an overlapping relationship; and
a correlation relationship.

12. The medium of claim 8, wherein the selecting one or more compressed targets comprises:
obtaining the predetermined criteria comprising a specified compression rate and a specified loss;
determining a loss for each of the compressing the original targets in the candidate compressed target;
identifying qualifying candidate compressed targets that have their respective losses satisfying the specified loss;
ranking the qualifying candidate compressed targets in an ascending order of their respective losses; and
selecting top ranked candidate compressed targets until the specified compression rate is satisfied.

13. The medium of claim 12, wherein the compression rate is defined based on a number of targets in the modified set and the number of original targets.

14. The medium of claim 8, wherein the information, when read by the machine, further causes the machine to perform the following steps:
collecting, in current operation of the network, real-time feature data characterizing the components of the network in the operation;
providing the real-time feature data to the target prediction models; and
predicting, by each of the target prediction models, metrics of an associated target in the modified set of targets based on the real-time feature data.

15. A system, comprising:
a feature data collection unit implemented by a processor and configured for collecting past metrics of a plurality of original targets measured in past operations of a network as well as past feature data characterizing components of the network;
a target compression unit implemented by a processor and configured for
creating model training data based on the collected past metrics and past feature data, wherein the model training data is for training target prediction models to predict metrics of the plurality of original targets,
generating combinations of the plurality of original targets,
identifying, from the combinations, candidate compressed targets, each of which includes original targets that are related to each other,
selecting one or more compressed targets from the candidate compressed targets based on predetermined criteria, and
creating a modified set of targets with both the selected compressed targets and remaining of the plurality of original targets;
a plurality of prediction model training units implemented by a processor and configured for deriving a target prediction model dedicated to predicting metrics of each target in the modified set of targets by:
extracting, from the model training data, relevant training data associated with the target, and
training, via machine learning, the target prediction model for the target based on the relevant training data.

16. The system of claim 15, wherein the combinations correspond to different groupings of the plurality of original targets.

17. The system of claim 15, wherein the identifying candidate compressed targets comprises:
with respect to each of the combinations,
identifying component original targets included in the combination,
retrieving past metrics of the component original targets from the model training data,
assessing whether the component original targets are related based on the retrieved past metrics,
designating the combination as a candidate compressed target if the component original targets are related.

18. The system of claim 15, wherein the selecting one or more compressed targets comprises:
obtaining the predetermined criteria comprising a specified compression rate and a specified loss;
determining a loss for each of the compressing the original targets in the candidate compressed target;
identifying qualifying candidate compressed targets that have their respective losses satisfying the specified loss;
ranking the qualifying candidate compressed targets in an ascending order of their respective losses; and
selecting top ranked candidate compressed targets until the specified compression rate is satisfied.

19. The system of claim 18, wherein the compression rate is defined based on a number of targets in the modified set and the number of original targets.

20. The system of claim 15, further comprising a feature data collection unit implemented by a processor and configured for:
collecting, in current operation of the network, real-time feature data characterizing the components of the network in the operation; and
providing the real-time feature data to the target prediction models, each of which predicts metrics of an associated target in the modified set of targets based on the real-time feature data.
